(19) United States
(12) Patent Application Publication
(10) Pub. No.: US 2022/0402817 A1
(43) Pub. Date: Dec. 22, 2022

(54) DRY MIXTURE FOR THE PREPARATION OF CONCRETE, FRESH CONCRETE AND METHOD FOR THE PREPARATION OF FRESH CONCRETE

(71) Applicant: ERC-TECH A.S., Nove Mesto (CZ)

(72) Inventors: Frantisek POLAK, Ricmanice (CZ); Lucie SLAVICKOVA, Zelesice (CZ); Jiri FIALA, Vedrovice (CZ); Jan CERMAK, Ivancice, Nemicice (CZ)

(21) Appl. No.: 17/774,289

(22) PCT Filed: Feb. 20, 2020
(86) PCT No.: PCT/CZ2020/050007

§ 371 Date: May 4, 2022

(30) Foreign Application Priority Data
Sep. 13, 2019 (CZ) PV 2019-586

(51) Int. Cl. C04B 18/16; C04B 28/02; C04B 14/06; C04B 18/02; C04B 18/14; C04B 14/14; C04B 16/04

(52) U.S. Cl. CPC C04B 18/167; C04B 28/02; C04B 18/165; C04B 14/062; C04B 18/027; C04B 18/149; C04B 14/14; C04B 16/04; C04B 2103/63

(57) ABSTRACT

Fresh concrete which contains in 1 m3 50 to 300 kg of water, 135 to 400 kg of cement or 135 to 600 kg of a mixture of cement and at least one substituent thereof, 10 to 150 kg of finely ground brick, ceramic, mixed or concrete recyclate having a particle size of 5 to 250 microns and a specific surface of 300 to 1500 m2/kg or 10 to 150 kg of a mixture of finely ground brick, ceramic, mixed or concrete recyclate having a particle size of 5 to 250 microns and a specific surface of 300 to 1500 m2/kg and microsilica and/or at least one substituent thereof, with a content of finely ground recyclate in this combination of at least 10% by weight, and 1000 to 2300 kg of aggregate.

### TECHNICAL FIELD

The present invention relates to fresh concrete with at least a part of the aggregate being replaced with recyclate from an inert construction and demolition waste and to a dry mixture for the preparation of this concrete.

The invention also relates to a method for the preparation of this concrete.

### BACKGROUND ART

According to qualified estimates, approximately 6.5 billion tons of inert construction and demolition waste is produced worldwide every year. The substantial majority of this waste is accumulating in landfills and dumps, and only a relatively small part is used or processed—most often, however, in a way that does not exploit the full potential of this material, which serves as a matter of fact merely to fill some empty space. Crushed or ground inert construction and demolition waste is used mainly for packs and backfills of utility lines (a substitute for sorted gravel), as a sub-base for parking lots, roads, concrete structures of floors of buildings and halls, backfills of forefields of bridges, for the consolidation and levelling of forest and field roads (as a substitute for a crusher-run materials), or as a sub-base filler of ground bodies of driveways and roads, trackbeds, flood protection barriers (as a substitute for soil), etc.

In addition, methods for the preparation of concrete in which crushed or ground inert construction and demolition waste is used as replacement of part of aggregate are also known. A common disadvantage of these methods which are based on conventional procedures for the preparation of conventional concretes, a typical example of which is the method described, for example, in CN 105036660, is above all the fact that that the concretes prepared by them either do not achieve the required physical and mechanical parameters or achieve them only at the cost of large additions of cement (and associated increase in production costs).

WO 2018177447 discloses a method for the preparation of concrete in which up to 100% of the aggregate consists of recycled material from inert construction and demolition waste, whereby this concrete achieves mechanical parameters comparable to conventional concretes. The disadvantage of this method is that it uses a relatively large amount of microsilica, the availability of which has been decreasing recently.

It is therefore an object of the present invention to provide a method for the preparation of concrete by replacing the largest possible part of aggregate with recyclate produced by grinding or crushing inert construction and demolition waste, which would enable to prepare concrete with mechanical and physical parameters comparable to conventional concretes, while not requiring an extra addition of cement or any other component.

Furthermore, the aim of the invention is also to provide fresh concrete and a dry mixture for its preparation in which the largest possible part of aggregate or of other components, is composed of recyclate produced by grinding or crushing inert construction and demolition waste.

### PRINCIPLE OF THE INVENTION

The method for the preparation of concrete according to the invention is based on a combination of a specific composition of the concrete and a specific procedure of mixing and dosing individual components of the concrete which in mutual combination allow to replace up to 100% by weight of natural aggregate in the concrete as well as a large proportion of fine concrete components with recyclate from inert construction and demolition waste (i.e. ground or crushed inert construction and demolition waste) while achieving mechanical and physical parameters which are at least comparable to conventional concretes.

Recyclate from inert construction and demolition waste which replaces aggregate consists of crushed or ground brick, ceramic, mixed or concrete recyclate (see below) and can have virtually any fraction according to desired properties and the applications of the concrete—the same or similar fraction to the standard natural aggregate, the upper fraction of the recyclate being, for example, preferably 8 or 16 or 20 mm, alternatively between 8 and 16 mm, or any other.

Recyclate from inert construction and demolition waste which replaces fine concrete components consists of finely ground brick, ceramic, mixed or concrete recyclate (see below) having a particle size of 5 to 250 μm, preferably 5 to 125 μm (it may contain some technological proportion of larger particles) and having a specific surface of 300 to 1500 m²/kg. This finely ground recyclate contains amorphous siliceous and aluminous components which react upon contact with water and Ca(OH)₂ to form new hydration C-S-H phases which are almost the same as in the minerals of Portland cement clinker. Due to this, it contributes significantly to pozzolanic reaction which occurs during hydration processes in concrete. Furthermore, this finely ground recyclate (optionally together with microsilica and/or at least one substituent thereof) serves mainly to fill pores and to coat the grains of the recyclate replacing aggregate, thereby strengthening them and improving their mechanical properties. The experiments described below clearly demonstrated the positive effect of this arrangement on the transition zone between recyclate and cement paste and thus the higher volume of C-S-H gels than in conventional concretes.

The term microsilica denotes an anti-corrosion powder additive for concrete and mortar, based on amorphous SiO₂ with a microfiller, pozzolanic and rheological effect. The usual grain size of microsilica is 100%<100 μm, its specific surface being 20 to 22 m²/g.

A typical chemical composition of the finely ground recyclate from inert construction and demolition waste is shown below in Table 1.

TABLE 1

| Component | Content [%] |
|---|---|
| SiO₂ | 35 to 65 |
| CaO | 5 to 35 |
| Al₂O₃ | 5 to 45 |
| Fe₂O₃ | 1 to 10 |
| MgO | 1 to 10 |
| K₂O | 0.5 to 2 |
| TiO₂ | 0.3 to 1 |
| SO₃ | 0.2 to 1.0 |
| K₂O | 0.5 to 2.0 |

Any excess of finely ground recyclate, preferably concrete recyclate, after the coating of the grains of the recyclate replacing aggregate and after filling their pores, can serve in the later stages of concrete preparation due to its pozzolanic properties as a replacement of part of the dose of cement or as a supplementary material and is incorporated in cement paste which is formed by moistening the cement or also substituent(s) thereof (the minimum amount of finely ground recyclate required to coat the grains of the recyclate replacing the aggregate and to fill their pores is approximately 10 kg/m³ of concrete). If necessary, an additional dose of finely ground recyclate, preferably concrete recyclate, can be added to the concrete before or simultaneously with or after the addition of cement and/or substituent(s) thereof, whereby this dose serves as a substitute for part of the cement or as a supplementary cementitious material and is incorporated into the cement paste formed by moistening cement or substituent(s) thereof.

The fresh concrete prepared by this method contains in 1 m³ 50 to 300 kg of water, 135 to 400 kg of cement or 135 to 600 kg of cement in combination with at least one substituent thereof (including finely ground recyclate from inert construction and demolition waste) with a cement content of 30 to 70% by weight, 10 to 150 kg of finely ground brick or ceramic or mixed or concrete recyclate from inert construction and demolition waste having a particle size of 5 to 250 μm, preferably 5 to 125 μm, and having a specific surface of 300 to 1500 m²/kg, or this finely ground recyclate in combination with microsilica and/or at least one substituent thereof with a content of finely ground recyclate in this combination of at least 10% by weight, and 1000 to 2300 kg of aggregate. 45 to 100% by weight of this aggregate is composed of recyclate from inert construction and demolition waste, preferably with an upper fraction of 8 or 16 or 20 mm. In addition, dust-free concrete recyclate without particles of less than 1 mm, which is the output of some recycling technologies, can be used. As a substituent of microsilica, for example, metakaolin, shale, ground-granulated blast-furnace slag (GGBS or GGBFS), fly ash is used.

The grains of the recyclate replacing aggregate or natural aggregate are coated in the concrete structure and their pores are filled with finely ground recyclate or, optionally, with this recyclate combined with microsilica and/or at least one substituent thereof, and the cement paste which is produced by moistening cement or also by moistening substituent(s) thereof (see below) is deposited on the surface of the grains thus treated.

For the purposes of the present application, by “brick recyclate” is meant herein a recyclate (recycled material) made by crushing or grinding inert construction and demolition waste, which consists entirely or of at least a majority of bricks, possibly with admixtures of other building materials and/or substances (concrete, ceramic building elements and fittings, mortar, plaster and adhesive residues, etc.). Thus, brick recyclate consists entirely or of at least of a majority of crushed brick, with the possible addition of rubble from other building materials and/or substances.

The term “ceramic recyclate” as employed herein denotes a recyclate (recycled material) made by crushing or grinding inert construction and demolition waste which consists entirely or of at least a majority of ceramic building and fitting elements, such as floor and wall tiles, sanitary ceramic products, clay roofing tiles, etc., possibly with admixtures of other building materials and/or substances (concrete, bricks, mortar, plaster and adhesive residues, etc.). Thus, ceramic recyclate consists entirely or of at least a majority of crushed ceramics, possibly with the addition of rubble from other building materials and/or substances. Brick, ceramic or mixed recyclate from mixed inert construction and demolition waste have similar characteristics and behavior and can therefore be interchanged or mixed.

By “concrete recyclate” is meant herein a recyclate (recycled material) made by crushing or grinding inert construction and demolition waste which consists entirely or of at least a majority of concrete or another cement containing material (concrete screed, cement mortar, etc.), possibly with admixtures of other building materials and/or substances (brick, ceramic building and fitting objects, mortar, plaster and adhesive residues, etc.). Thus, concrete recyclate consists entirely or of at least a majority of crushed concrete or another cement containing material, with the possible addition of rubble from other building materials and/or substances.

Under the term “mixed recyclate” as employed herein we understand a recyclate (recycled material) made by crushing or grinding mixed inert construction and demolition waste which is composed of a mixture of different building materials and substances, usually brick, concrete and ceramic building elements and fittings in various ratios, possibly with admixtures of mortar, plaster and adhesive residues, etc., Thus, mixed recyclate is composed of rubble from mixed construction and demolition waste.

In addition to the above, finely ground brick recyclate also denotes fine dust from brick grinding and brick kilns that meets the above-mentioned condition of particle size and specific surface.

0 to 40% by weight of aggregate in the concrete may be composed of natural aggregate (extracted and/or crushed) preferably with a fraction of 0 to 20 mm, 0 to 16 mm, or 0 to 8 mm, alternatively 0 to 4 mm. Further 0 to 40 wt. % of aggregate, preferably 0 to 20% by weight or 0 to 15.% by weight may be formed by at least one known admixture which enhances the thermal and/or acoustic and/or fire-resistant properties of the concrete and which is commonly used in conventional concretes. Such admixture is, e.g., lightweight artificial aggregate (such as agloporite, ceramsite, expandit, expanded perlite, etc.), cinder and/or scoria and/or polystyrene and/or at least one organic filler (such as wood sawdust, shavings, rice husks, shives and the like), etc.

When using recyclate from inert construction and demolition waste (or also natural aggregate) with a fraction of 0 to 8 mm, fresh concrete with a finer texture is prepared, sometimes referred to as cement mortar or concrete mortar.

In preferred variants, fresh concrete contains in 1 m³ 180 to 250 kg of water, 180 to 250 kg of cement supplemented with 0 to 150 kg of at least one substituent of cement (including finely ground recyclate from inert construction and demolition waste), 10 to 150 kg of finely ground recyclate from inert construction and demolition waste or 10 to 150 kg of a mixture of finely ground recyclate from inert construction and demolition waste having a particle size of 5 to 250 microns and having a specific surface of 300 to 1500 m²/kg and 0 to 20 kg of mikrosilica and/or at least one substituent thereof and 1160 to 2255 kg of recyclate from inert construction and demolition waste replacing aggregate. The grains of the recyclate replacing aggregate are coated with the finely ground recyclate or with this recyclate in combination with microsilica and/or at least one substituent thereof and their pores are filled with the finely ground recyclate or with this recyclate in combination with microsilica and/or at least one substituent thereof, whereby cement paste, which is formed by moistening the cement or also the substituent(s) thereof, is deposited on the surface of the grains thus treated.

If necessary, the fresh concrete according to the invention may contain in any variant at least one additive for concrete or a mixture of two or more additives for concrete in an amount of up to 10% by weight of a dose of cement or of a dose of cement and substituent(s) thereof. Any known additive can be used as such an additive, for example an additive for vibro-pressed concrete and/or an additive according to EN 934-2. These additives include especially water-reducing (plasticizing) and strongly water-reducing (superplasticizing or hyperplasticizing) additives to improve the consistency of concrete, water-reducing additives, additives for improving strength and some other properties of fresh and hardened concrete, as well as stabilizing additives, air-entraining additives, foaming additives, additives accelerating hardening and solidification of concrete, additives retarding hardening and solidification of concrete, sealing agents, etc. This additive/these additives is/are added to the other components of the concrete dissolved in mixing water or separately, preferably after the addition of mixing water.

To mix the individual components thoroughly and to prepare concretes (or dry mixtures) of the desired structure and properties, any industrial mixer can be used, preferably a mixer with a forced circulation, e.g. a mixer with a radial movement of mixing arms or with a double simultaneous radial movement of mixing arms (such as the mixer described in IT 1244970 or EP 0508962), in which all its interior surfaces are wiped. In addition, any other type of industrial mixer can be used, including continuous mixers (using a pre-prepared dry mixture). However, the order of introduction of the individual concrete components into the mixer must be observed. All ingredients are dosed while the mixer is running. For the purposes of this application, mixing is understood to include also the mixing methods in which the mixer operation is temporarily stopped after mixing the already added components and before the addition of the next component, or, if the mixer design allows it, reversing the running of the mixer for addition of another component and mixing it together with the other components. These adjustments to the mixer operation, however, have no effect on the properties or consistency of the fresh concrete being prepared (or of the dry mixture), nor on the subsequently hardened concrete and its properties.

Prior to the preparation of the concrete according to the invention, the recyclate from inert construction and demolition waste is hygienized, e.g. by water or steam bath or using another method, thereby reducing the number of (pathogenic) organisms and microorganisms present in it.

While observing the below-described dosing and mixing methods, the finely ground recyclate from inert construction and demolition waste, which is not used in standard concrete production, serves (optionally in combination with microsilica and/or at least one substituent thereof) in the preparation of the concrete according to the invention to coat the particles of the aggregate, especially the particles of the recyclate replacing the aggregate, and to fill their pores. At the same time, part of the transit zone (C-S-H phases) is transferred to the pores of the grains of the recyclate replacing the aggregate, and thus strengthened, which results in a strengthening of the grains of the recyclate; there is no clustering of fine particles and the resulting concrete has a lower porosity and, after hardening, it reaches physical and mechanical parameters comparable to conventional concretes.

Finely ground recyclate from inert construction and demolition waste (alternatively in combination with microsilica and/or at least one substituent thereof) is added to the mixer either together with aggregate (or one of its components), or only after thorough dry mixing of all the aggregate components. In addition, the total dose of the finely ground recyclate from inert construction and demolition waste (optionally in combination with microsilica and/or at least one substituent thereof), as well as the total dose of the aggregate can be divided into two or more smaller parts (equal or different), and the individual parts of the dose of the finely ground recyclate from inert construction and demolition waste (optionally in combination with microsilica and/or at least one substituent thereof) can be added one by one after the addition of the individual parts of the total dose of the aggregate, or of the recyclate from construction and demolition waste of different types and/or fractions, or at least some parts of the dose of the finely ground recyclate from inert construction and demolition waste (optionally in combination with microsilica and/or at least one substituent thereof) can be added simultaneously with some parts of the total dose of the aggregate or recyclate.

The rubbing contact of the grains of the recyclate from inert construction and demolition waste replacing aggregate during dry mixing results in their intense abrasion, which not only leads to an increase in the specific surface of this recyclate, but also to formation of a small amount of fine pozzolanic powder which, together with the finely ground recyclate from inert construction and demolition waste (and optionally also in combination with microsilica and/or at least one substituent thereof) coats the grains of the aggregate, especially the grains of the recyclate from inert construction and demolition waste replacing the aggregate, and fills the pores in them.

All variants use cement of strength class CEM I to CEM V with binding capacity 32.5 N, R, 42.5 N, R, 52.5 N, R. Its dosing method as described below ensures formation of a suitable bond between cement paste, which is obtained by moistening the cement or the substituent thereof, and aggregate, especially recyclate from inert construction and demolition waste already coated with finely ground recyclate from inert construction and demolition waste (optionally also in combination with microsilica and/or at least one substituent thereof). Moreover, it ensures very good homogenization of the mixture being mixed (see below).

Part of the cement dose may be replaced with a substituent of cement, such as ground-granulated blast-furnace slag (GGBS or GGBFS) and/or fly ash and/or finely ground calcium carbonate (GCC) and the like, or a mixture of at least two such substituents, whereby the ratio of cement to substituent(s) of cement in fresh concrete ranges from 30:70 to 70:30. The total amount of cement and substituent(s) of cement is the same as the amount of cement alone, i.e. 135 to 400 kg/m³ of fresh concrete, or up to 600 kg/m³ of fresh concrete. Cement and substituent(s) of cement are added to the mixture either simultaneously, each separately, or one by one in any order, (it is advisable, but not necessary, to add substituent(s) of cement first and cement after that), or in the form of a pre-prepared mixture of the composition described above. Due to its excellent pozzolanic properties, finely ground recyclate from inert construction and demolition waste, in particular concrete recyclate, having a particle size of 5 to 250 μm, preferably 5 to 125 μm, and with a specific surface of 300 to 1500 m²/kg, can also serve as a substituent of cement in a dose of 10 to 150 kg/m³ of fresh concrete.

After forming and mixing the dry mixture of the above ingredients, the mixture is sprinkled or sprayed with mixing water in the mixer under constant mixing. As a result of this method of dosing the mixing water combined with continuous mixing, the cement surface and/or the surface of substituent(s) thereof is gradually moistened and the thus formed (cement) paste gradually adheres to the recyclate grains already coated with finely ground recyclate from inert construction and demolition waste (optionally in combination with microsilica and/or at least one substituent thereof). With this dosing method, silicon dioxide contained in the finely ground recycled material (or also in the microsilica and/or in at least one of its substituents) is activated, thereby activating the latent hydraulicity of these components, which allows the concretes prepared by this method to achieve physical and mechanical parameters comparable to conventional concretes, even with a cement dose that may be lower than in conventional concretes.

The mixing water quality must correspond to drinking water. If required, the mixing water may contain at least one known standard additive for concrete (dissolved or undissolved).

The recyclate from inert construction and demolition waste may be supplemented with natural aggregate (extracted and/or crushed) with an upper fraction of preferably 8 or 16 or 20 mm, or also smaller or greater, according to the requirements and according to the intended use of concrete.

In the preparation of 1 m³ of fresh concrete according to the invention, 1000 to 2300 kg of aggregate, in which 45% by weight to 100% by weight is formed by recyclate from inert construction and demolition waste, is first mixed in an industrial mixer with 10 to 150 kg of finely ground recyclate from inert construction and demolition waste having a particle size of 5 to 250 μm, preferably 5 to 125 μm, and having a specific surface of 300 to 1500 m²/kg, or of the finely ground recyclate in combination with microsilica and/or at least one substituent thereof, with a content of the finely ground recyclate in this combination of at least 10% by weight. This process involves coating the grains of the aggregate, especially of the recyclate replacing the natural aggregate, and filling its pores with the finely ground recyclate (and optionally also with microsilica and/or at least one substituent thereof). After mixing, 135 to 400 kg of cement is added to the mixture thus obtained under constant mixing, or cement and at least one substituent thereof in a total amount of 135 to 400 kg or of up to 600 kg (whereby the ratio of cement to substituent(s) of cement ranges from 30:70 to 70:30) is added either one by one in any order or simultaneously. The dry mixture thus obtained is further mixed and, under constant mixing, is sprinkled with 50 to 300 kg of mixing water, or this amount of mixing water is gradually sprayed onto it. As a result, the cement surface and/or the surface of substituent(s) thereof is gradually moistened and the (cement) paste being formed gradually adheres to the aggregate particles already coated with the finely ground recyclate from inert construction and demolition waste (optionally, in combination with microsilica and/or at least one substituent thereof), and after further mixing fresh concrete is prepared.

If necessary, only the aggregate (recyclate or also natural aggregate) is first mixed in the mixer and the finely ground recyclate from inert construction and demolition waste (optionally in combination with a microsilica and/or at least one of its substituents) is added to it only after the mixing of the aggregate and its homogenization.

When using an industrial mixer with forced circulation, the individual steps take place preferably, but not necessarily, at certain time intervals. For example, the aggregate is preferably mixed with the finely ground recyclate from inert construction and demolition waste for 5 to 80 seconds, more preferably for 5 to 40 seconds. Cement or cement and at least one substituent thereof is/are added to the mixture thus obtained preferably within 1 to 20 seconds after finishing the mixing of the aggregate with the finely ground recyclate, more preferably within 1 to 10 seconds, and the mixture thus obtained is mixed preferably for 5 to 80 seconds, more preferably for 5 to 40 seconds, whereupon the mixture mixed is sprinkled with mixing water under constant mixing preferably within 5 to 60 seconds, more preferably within 5 to 40 seconds, or the mixing water is sprayed onto it. After that, the mixture thus obtained is mixed until it has the required consistency, preferably for another 5 to 160 seconds, more preferably for 5 to 80 seconds, to prepare fresh concrete.

If necessary, only the aggregate is first mixed in the mixer, preferably for 5 to 40 seconds, more preferably for 5 to 20 seconds, and the finely ground recyclate from inert construction and demolition waste (optionally in combination with microsilica and/or with at least one substituent thereof) is added to it only after thorough mixing, preferably within 1 to 15 seconds, more preferably within 1 to 10 seconds.

By analogy, it is possible to prepare a dry mixture for the preparation of such fresh concrete without the addition of mixing water or without the addition of cement and its substituent(s). This dry mixture then contains in 1 m³ of fresh concrete 10 to 150 kg of finely ground recycled from inert construction and demolition waste having a particle size of 5 to 250 μm, preferably 5 to 125 μm, and having a specific surface of 300 to 1500 m²/kg, or of this finely grounded recyclate in combination with microsilica and/or at least one substituent thereof (with a content of finely ground recyclate of at least 10% by weight), and 1000 to 2300 kg of aggregate, whereby 45 to 100% by weight of this aggregate consists of recyclate from inert construction and demolition waste with an upper fraction of preferably 8 or 16 or 20 mm, or any other fraction, whereby the aggregate grains are coated with finely ground recyclate from inert construction and demolition waste or with a mixture of finely ground recyclate from inert construction and demolition waste and microsilica and/or at least one substituent of microsilica, and their pores are filled with this finely ground recyclate or with the mixture of the finely ground recyclate and microsilica and/or at least one substituent thereof. In another variant, the dry mixture may further contain, when computed for 1 m³ of fresh concrete 135 to 400 kg of cement, or simultaneously cement and at least one substituent thereof in a total amount of 135 to 400 kg or up to 600 kg (whereby the ratio of cement and substituent(s) of cement ranges from 30:70 to 70:30). Any known mixer type including continuous mixers, can be used to prepare fresh concrete from this dry mixture.

### EXAMPLES OF EMBODIMENT

Examples of the preparation of fresh concrete according to the invention are described below for illustration.

### Example 1

For the preparation of concrete according to the invention, brick, ceramic, concrete or mixed recyclate from mixed inert construction and demolition waste with an upper fraction of 20 mm is mixed in an industrial mixer with forced circulation for 5 to 40 seconds, preferably for 5 to 20 seconds. After thorough mixing, finely ground brick, ceramic, mixed or concrete recyclate having a particle size of 5 to 250 μm, preferably 5 to 125 μm, and having a specific surface of 300 to 1500 m²/kg is added to it under constant mixing within 1 to 15 seconds, preferably within 1 to 10 seconds, or finely ground brick, ceramic, mixed or concrete recyclate and microsilica and/or at least one substituent thereof are added either one by one in any order or simultaneously, and the mixture thus obtained is mixed for a further 5 to 80 seconds, preferably for 5 to 40 seconds. Thereafter, cement is added to it under constant mixing within 1 to 20 seconds, preferably within 1 to 10 seconds, or cement and at least one substituent thereof is added to it either one by one in any order or simultaneously within 1 to 15 seconds, preferably within 1 to 10 seconds, and the mixture thus obtained is mixed for a further 5 to 80 seconds, preferably for 5 to 40 seconds. As a substituent of cement, another dose of finely ground recyclate from inert construction and demolition waste can be used, preferably concrete recyclate having a particle size of 5 to 250 μm, preferably 5 to 125 μm and having a specific surface of 300 to 1500 m²/kg. Subsequently, this mixture is sprinkled with the entire dose of mixing water (which, if necessary, contains at least one additive for concrete) within 5 to 60 seconds, preferably within 5 to 40 seconds, under constant mixing, or it is sprayed with the entire dose of the mixing water within 5 to 60 seconds, preferably within 5 to 40 seconds. After another 5 to 160 seconds, preferably 5 to 80 seconds, of mixing, fresh concrete is prepared, in which 100% by weight of aggregate is composed of recyclate from inert construction and demolition waste.

10 samples of fresh concrete according to the invention were prepared by this method, whereby the composition of 1 m³ of each of them is described in Table 2.

The fresh concretes thus prepared were subjected to consistency tests according to EN 12350-2 and air content was measured according to EN 12350-7.

From these fresh concretes, 150 mm cubes were created for the compressive strength test according to EN 12390-3, 100 mm×100 mm×400 mm prisms were formed for testing flexural strength according to EN 12390-5, for the measurement of volume changes according to CSN (Czech Technical Standard) 73 1320, for the measurement of static modulus of elasticity according to ISO 1920-10 and 200 mm×200 mm×50 mm boards were formed for thermal conductivity test. After the hardening of concrete, the test bodies were removed from the molds on the following day and stored for the respective tests in an air-conditioned chamber at a temperature of 20±2° C. and a relative humidity above 95%. Parameters measured during these tests are summarized in Table 3.

TABLE 2

| Sample Component | ERC 1/1 | ERC 1/2 | ERC 1/3 | ERC 1/4 | ERC 1/5 | ERC 1/6 | ERC 1/7 | ERC 1/8 | ERC 1/9 | ERC 1/10 |
|---|---|---|---|---|---|---|---|---|---|---|
| Mixed recyclate | 0 | 0 | 0 | 1300 | 1450 | 0 | 0 | 0 | 0 | 0 |
| from mixed inert | | | | | | | | | | |
| construction | | | | | | | | | | |
| and demolition | | | | | | | | | | |
| waste, | | | | | | | | | | |
| fraction 0 to 20 | | | | | | | | | | |
| mm [kg] | | | | | | | | | | |
| Brick recyclate, | 0 | 0 | 0 | 0 | 0 | 0 | 0 | 1420 | 1200 | 0 |
| fraction 0 to 20 | | | | | | | | | | |
| mm [kg] | | | | | | | | | | |
| Ceramic | 0 | 0 | 0 | 0 | 0 | 0 | 0 | 0 | 0 | 1160 |
| recyclate, | | | | | | | | | | |
| fraction 0 to 20 | | | | | | | | | | |
| mm [kg] | | | | | | | | | | |
| Concrete | 1500 | 1570 | 1250 | 0 | 0 | 2255 | 1670 | 0 | 0 | 0 |
| recyclate, | | | | | | | | | | |
| fraction 0 to 20 | | | | | | | | | | |
| mm [kg] | | | | | | | | | | |
| Microsilica [kg] | 5 | 0 | 0 | 10 | 5 | 0 | 0 | 0 | 15 | 20 |
| Finely ground | 15 | 30 | 50 | 60 | 95 | 10 | 120 | 150 | 35 | 50 |
| recyclate from | | | | | | | | | | |
| inert | | | | | | | | | | |
| construction | | | | | | | | | | |
| and demolition | | | | | | | | | | |
| waste [kg] | | | | | | | | | | |
| Cement [kg] | 200 | 230 | 360 | 190 | 210 | 230 | 230 | 180 | 250 | 250 |
| Substituent of | 150/50 | 140/100 | 40/40 | 140/70 | 90/10 | 0 | 50/20 | 60/30 | 100/100 | 150/150 |
| cement [kg]/ | | | | | | | | | | |
| finely ground | | | | | | | | | | |
| recyclate from | | | | | | | | | | |
| inert | | | | | | | | | | |
| construction | | | | | | | | | | |
| and demolition | | | | | | | | | | |
| waste [kg] | | | | | | | | | | |
| Concrete | 4.7 | 2 | 4.6 | 5.0 | 5.0 | 0 | 0 | 5.4 | 5.2 | 5.1 |
| plasticizer | | | | | | | | | | |
| or | | | | | | | | | | |
| superplasticizer | | | | | | | | | | |
| [kg] | | | | | | | | | | |
| Water [kg] | 235 | 245 | 195 | 282 | 286 | 215 | 257 | 202 | 265 | 272 |
| Aerating agent | 0 | 0 | 0.9 | 0 | 0 | 0 | 0 | 0 | 0 | 0 |
| for concrete [%] | | | | | | | | | | |
| Volume weight | 2110 | 2170 | 1760 | 1940 | 2090 | — | 2190 | 1990 | 1 850 | 1870 |
| of concrete at | | | | | | | | | | |
| age of 7 days | | | | | | | | | | |
| [kg/m³] | | | | | | | | | | |
| Volume weight | 2100 | 2150 | 1750 | 1 935 | 2080 | — | 2195 | 1990 | 1845 | 1862 |
| of concrete at | | | | | | | | | | |
| age of 28 days | | | | | | | | | | |
| [kg/m³] | | | | | | | | | | |

TABLE 3

| Sample Parameter | ERC 1/1 | ERC 1/2 | ERC 1/3 | ERC 1/4 | ERC 1/5 | ERC 1/6 | ERC 1/7 | ERC 1/8 | ERC 1/9 | ERC 1/10 |
|---|---|---|---|---|---|---|---|---|---|---|
| Consistency of fresh | 200 | 130 | 150 | 170 | 230 | 40 | 80 | 190 | 230 | 220 |
| concrete - slump | | | | | | | | | | |
| cone test [mm] | | | | | | | | | | |
| Air content in fresh | 3.5 | 3.0 | 2.9 | 3.8 | 3.4 | — | — | 4.0 | 4.5 | 4.8 |
| concrete [%] | | | | | | | | | | |
| Compressive | | | | | | | | | | |
| strength [MPa] | | | | | | | | | | |
| After 7 days | 24.50 | 28.0 | 25.60 | 18.50 | 20.80 | 12.8 | 17.7 | 19.4 | 20.5 | 22.2 |
| After 14 days | 29.40 | 33.50 | 31.0 | 28.70 | 27.80 | 17.5 | 24.9 | 27.9 | 27.7 | 28.7 |
| After 28 days | 37.0 | 42.20 | 39.10 | 33.20 | 34.50 | 24.6 | 33.9 | 35.9 | 33.2 | 34.5 |
| Flexural strength | 5.50 | 4.70 | 5.10 | 2.60 | 3.50 | 2.1 | 1.9 | 2.70 | 3.7 | — |
| after 28 days [MPa] | | | | | | | | | | |
| Depth of water | 22 | 12 | — | 20 | 16 | 30 | — | 25 | — | 28 |
| penetration under | | | | | | | | | | |
| pressure [mm] | | | | | | | | | | |

In addition, chloride content in these concretes was determined by calculation according to EN 196-2 and EN 1744-1, the content of natural radionuclides and mass activity index were determined according to the procedure of Regulation of the State Office for Nuclear Safety No. 307/2002 Coll., as amended, on radiation protection, whereby all these parameters meet the requirements of this Regulation for use for buildings with residential rooms or spaces (mass activity ²²⁶Ra≤150 Bq·kg⁻¹, mass activity index I≤0.5). According to the procedure of EN 12457 and Regulation of the Ministry of the Environment No. 294/2005 Coll. its ecotoxicity was found to be complying with the requirements. The criteria for the determination of ecotoxicity are summarized in Table 4.

TABLE 4

| | Exposure time | | |
|---|---|---|---|
| Tested organism | [hours] | I | II |
| Water arthropod | 48 | Max. | Max. |
| Daphnia magna | | immobilization | immobilization |
| | | 30% | 30% |
| Aquatic vertebrate | 96 | without death | without death |
| Poecillia reticulata | | and behavioral | and behavioral |
| | | change | change |
| Alga Desmodesmus | 72 | Max. inhibition | Max. change in |
| subspicatus | | 30% | growth 30% |
| Seeds of the plant | 72 | Max. inhibition | Max. change in |
| Sinapis alba | | 30% | growth 30% |

Table 5 shows strength classes of concrete to which the respective concretes belong due to their physical and mechanical parameters and classification classes of specification regarding use of these concretes according to CSN (Czech Technical Standard) EN 206 (see Table 6).

TABLE 5

| Sample | ERC 1/1 | ERC 1/2 | ERC 1/3 | ERC 1/4 | ERC 1/5 | ERC 1/6 | ERC 1/7 | ERC 1/8 | ERC 1/9 | ERC 1/10 |
|---|---|---|---|---|---|---|---|---|---|---|
| Concrete | C25/30 | C30/37 | C25/30 | C20/25 | C25/30 | C16/20 | C20/25 | C25/30 | C20/25 | C25/30 |
| strength | | | | | | | | | | |
| class | | | | | | | | | | |
| Specification | X0 | XF1 | X0 | X0 | X0 | X0 | X0 | X0 | X0 | X0 |
| of concrete | XC1 | | XC1 | XC1 | XC1 | XC1 | XC1 | XC1 | XC1 | XC1 |
| use | XC2 | | XC2 | XC2 | XC2 | XC2 | XC2 | XC2 | XC2 | XC2 |
| | XC3 | | XC3 | | XC3 | XC3 | XC3 | XC3 | XC3 | XC3 |
| | XC4 | | XC4 | | XC4 | XC4 | XC4 | XC4 | XC4 | XC4 |
| | XD1 | | XD1 | | XD1 | | XD1 | XD1 | XD1 | XD1 |
| | XD2 | | XD2 | | XD2 | | XD2 | XD2 | XD2 | XD2 |
| | XF1 | | XF1 | | XF1 | | XF | XF1 | | XF1 |
| | | | XF2 | | | | | | | |

TABLE 6

| | | |
|---|---|---|
| Class | Description of degree of | Informative examples where |
| designation | environmental impact | exposure classes may occur |

for concrete with no risk of corrosion or attack

| | | |
|---|---|---|
| X0 | For concrete without re- | Concrete inside buildings with |
| | inforcement or embedded metal | very low humidity |
| | inserts. All exposures, | |
| | except where there is freeze/ | |
| | thaw, abrasion or aggressive | |
| | chemical environment | |
| | For reinforced concrete or | |
| | concrete with embedded metal | |
| | inserts: Very dry | |

for concrete with risk of corrosion induced by carbonation

| | | |
|---|---|---|
| XC1 | Dry or permanently wet. | Concrete inside buildings with |
| | | very low humidity; |
| | | Concrete permanently |
| | | submerged in water. |
| XC2 | Wet, rarely dry. | Concrete surfaces subject to |
| | | long-term water contact; |
| | | Most foundations. |
| XC3 | Moderate humidity. | Concrete inside buildings with |
| | | moderate or high air humidity; |
| | | External concrete sheltered |
| | | from rain. |
| XC4 | Cyclic wet and dry. | Concrete surfaces subject to |
| | | water contact, not within |
| | | exposure class XC2 |

for concrete with risk of corrosion induced by chlorides other
than from sea water

| | | |
|---|---|---|
| XD1 | Moderate humidity. | Concrete surfaces exposed to |
| | | airborne chlorides. |
| XD2 | Wet, rarely dry. | Swimming pools. Concrete |
| | | exposed to industrial waters |
| | | containing chlorides. |

for concrete exposed to freeze/thaw attack, without chemical
de-icing agents

| | | |
|---|---|---|
| XF1 | Moderate water saturation, | Vertical concrete surfaces |
| | without de-icing agents. | exposed to rain and freezing |
| XF2 | Moderate water saturation, | Vertical concrete surfaces of |
| | with de-icing agents | road structures exposed to |
| | | frost and de-icing agents |
| | | dispersed in air |
| Class | Description of degree of | Informative examples where |
| designation | environmental impact | exposure classes may |
| | | occur |
| XF4 | High water saturation, with | Roads and bridge decks |
| | de-icing agents or sea water | exposed to de-icing agents, |
| | | concrete surfaces exposed to |
| | | direct spray, splashed zone of |
| | | marine structures exposed to |
| | | freezing |

for concrete exposed to the chemical effects of soil and
groundwater

| | | |
|---|---|---|
| XA1 | Slightly aggressive chemical | Concrete exposed to natural |
| | environment | soils and groundwater |

### Example 2

For the preparation of concrete according to the invention, brick, ceramic or mixed recyclate from mixed inert construction and demolition waste with an upper fraction of 20 mm is mixed in an industrial mixer with forced circulation for 5 to 40 seconds, preferably for 5 to 20 seconds. After thorough mixing, concrete recyclate with an upper fraction of 20 mm or natural aggregate with an upper fraction of 20 mm, preferably 8 mm, or small aggregate with an upper fraction of 4 mm (up to 40% by weight of the total aggregate in the concrete) is added to it under constant mixing, and the mixture thus obtained is mixed for another 5 to 40 seconds, preferably for 5 to 20 seconds. After thorough mixing, finely ground brick, ceramic, mixed or concrete recyclate having a particle size of 5 to 250 μm, preferably 5 to 125 μm, and having a specific surface of 300 to 1500 m²/kg or finely ground brick, ceramic, mixed or concrete recyclate and microsilica and/or at least one substituent of microsilica is added to it either one by one in any order or simultaneously under constant mixing within 1 to 15 seconds, preferably within 1 to 10 seconds, and the mixture thus obtained is mixed for a further 5 to 80 seconds, preferably for 5 to 40 seconds. After that, cement is added to it under constant mixing within 1 to 20 seconds, preferably within 1 to 10 seconds, or cement and at least one substituent thereof is added either one by one in any order or simultaneously within 1 to 15 seconds, preferably within 1 to 10 seconds, and the mixture thus obtained is mixed for another 5 to 80 seconds, preferably for 5 to 40 seconds. As a substituent of cement can be used a further dose of finely ground brick, ceramic, mixed or concrete recyclate having a particle size of 5 to 250 μm, preferably 5 to 125 μm, and having a specific surface of 300 to 1500 m²/kg, which is dispersed in the concrete structure. Subsequently, this mixture is sprinkled with the entire dose of mixing water (which, if necessary, contains at least one additive for concrete) under constant mixing within 5 to 60 seconds, preferably within 5 to 40 seconds, or the entire dose of the mixing water is sprayed on it within 5 to 60 seconds, preferably within 5 to 40 seconds. After another 5 to 160 seconds of mixing, preferably after 5 to 80 seconds, fresh concrete is prepared, in which 60 to 100% by weight of aggregate is composed of recyclate from inert construction and demolition waste.

8 samples of fresh concrete according to the invention were prepared by this method, whereby the composition of 1 m³ of each of them is described in Table 7.

These concretes were subsequently subjected to tests described in example 1. The results of these tests are summarized in Table 8.

In addition, chloride content in these concretes was determined by calculation according to EN 196-2 and EN 1744-1, the content of natural radionuclides and mass activity index were determined according to the procedure of Regulation of the State Office for Nuclear Safety No. 307/2002 Coll., as amended, on radiation protection, whereby all these parameters meet the requirements of this Regulation for use in buildings with residential rooms or spaces (mass activity ²²⁶Ra≤150 Bq·kg⁻¹, mass activity index I≤0.5). According to the procedure of EN 12457 and Regulation of the Ministry of the Environment No. 294/2005 Coll. its ecotoxicity was found to be complying with the requirements. The criteria for the determination of ecotoxicity are shown in Table 4, example 1.

Table 9 shows strength classes of concrete to which the respective concretes belong due to their physical and mechanical parameters and classification classes of specification regarding use of these concretes according to CSN (Czech Technical Standard) EN 206 (see Table 6)

TABLE 7

| Sample Component | ERC 2/1 | ERC 2/2 | ERC 2/3 | ERC 2/4 | ERC 2/5 | ERC 2/6 | ERC 2/7 | ERC 2/8 |
|---|---|---|---|---|---|---|---|---|
| Mixed recyclate from mixed | 1127 | 0 | 740 | 863 | 0 | 765 | 740 | 975 |
| inert construction and | | | | | | | | |
| demolition waste, fraction | | | | | | | | |
| 0 to 20 mm [kg] | | | | | | | | |
| Brick recyclate, fraction | 0 | 1137 | 0 | 0 | 0 | 0 | 0 | 0 |
| 0 to 20 mm [kg] | | | | | | | | |
| Ceramic recyclate, fraction | 0 | 0 | 0 | 0 | 650 | 0 | 0 | 0 |
| 0 to 20 mm [kg] | | | | | | | | |
| Concrete recyclate, fraction | 0 | 0 | 740 | 863 | 650 | 765 | 740 | 975 |
| 0 to 20 mm [kg] | | | | | | | | |
| Natural aggregate, fraction | 420 | 390 | 0 | 0 | 0 | 0 | 0 | 0 |
| 0 to 4 mm [kg] | | | | | | | | |
| Microsilica [kg] | 25 | 15 | 0 | 0 | 5 | 10 | 25 | 10 |
| Finely ground recyclate | 75 | 10 | 50 | 150 | 30 | 100 | 120 | 20 |
| from inert construction and | | | | | | | | |
| demolition waste [kg] | | | | | | | | |
| Cement [kg] | 240 | 230 | 220 | 230 | 230 | 190 | 180 | 190 |
| Substituent of cement [kg]/finely | 0 | 70/0 | 100/0 | 100/50 | 150/20 | 60/20 | 190/150 | 100/50 |
| ground recyclate from inert | | | | | | | | |
| construction and demolition | | | | | | | | |
| waste [kg] | | | | | | | | |
| Concrete plasticizer or | 0 | 0 | 6.6 | 6.9 | 7.6 | 4.5 | 4.8 | 4 |
| superplasticizer [kg] | | | | | | | | |
| Water [kg] | 200 | 205 | 230 | 215 | 235 | 175 | 235 | 100 |
| Volume weight of concrete | 2020 | 2017 | 2010 | 2370 | 1915 | 2030 | 2190 | 2310 |
| at age of 7 days [kg/m³] | | | | | | | | |
| Volume weight of concrete | 2015 | 2020 | 2010 | 2355 | 1910 | 2025 | 2190 | 2300 |
| at age of 28 days [kg/m³] | | | | | | | | |

TABLE 8

| Sample Parameter | ERC 2/1 | ERC 2/2 | ERC 2/3 | ERC 2/4 | ERC 2/5 | ERC 2/6 | ERC 2/7 | ERC 2/8 |
|---|---|---|---|---|---|---|---|---|
| Consistency of fresh | 35 | 30 | 180 | 200 | 220 | 80 | 220 | 60 |
| concrete - slump cone | | | | | | | | |
| test [mm] | | | | | | | | |
| Air content in fresh | 2.4 | 2.0 | 3.5 | 3.3 | 3.4 | 2.0 | 2.3 | 2.4 |
| concrete [%] | | | | | | | | |
| Compressive strength | | | | | | | | |
| [MPa] | | | | | | | | |
| After 7 days | 23.2 | 22.8 | 29.2 | 27.8 | 29.7 | 19.0 | 21.2 | 16.0 |
| After 28 days | 34.6 | 33.1 | 42.0 | 40.5 | 38.3 | 25.5 | 29.6 | 25.8 |
| Flexural strength | 3.3 | 3.1 | 4.5 | 4.2 | 3.9 | 2.8 | 2.9 | 2.3 |
| after 28 days [MPa] | | | | | | | | |
| Transverse tensile | 3.7 | — | 4.1 | — | — | — | 3.5 | 3.3 |
| strength after 28 | | | | | | | | |
| days [MPa] | | | | | | | | |
| Static modulus of | 25.2 | 25.7 | 20.2 | 19.7 | — | 17.0 | 17.3 | — |
| elasticity [GPa] | | | | | | | | |

TABLE 9

| Sample | ERC 2/1 | ERC 2/2 | ERC 2/3 | ERC 2/4 | ERC 2/5 | ERC 2/6 | ERC 2/7 | ERC 2/8 |
|---|---|---|---|---|---|---|---|---|
| Concrete | C25/30 | C20/25 | C30/37 | C25/30 | C25/30 | C16/20 | C20/25 | C16/20 |
| strength | | | | | | | | |
| class | | | | | | | | |
| Specification | X0 | X0 | X0 | X0 | X0 | X0 | X0 | X0 |
| of concrete | XC1 | XC1 | XC1 | XC1 | XC1 | XC1 | XC1 | XC1 |
| use | XC2 | XC2 | XC2 | XC2 | XC2 | | XC2 | |
| | XC3 | XC3 | XC3 | XC3 | XC3 | | XC3 | |
| | XC4 | XC4 | XC4 | XC4 | XC4 | | XC4 | |
| | XD1 | XD1 | XD1 | XD1 | XD1 | | XD1 | |
| | XD2 | XD2 | XD2 | XD2 | XD2 | | XD2 | |
| | XF1 | | XA1 | XF1 | XF1 | | | |
| | XF2 | | XF1 | XF2 | XF2 | | | |
| | | | XF2 | | | | | |
| | | | XF3 | | | | | |
| | | | XF4 | | | | | |

### Example 3

For the preparation of concrete according to the invention, recyclate from inert construction and demolition waste with an upper fraction of 20 mm of the first type (brick, ceramic or mixed, alternatively concrete recyclate) is mixed in an industrial mixer with forced circulation for 5 to 40 seconds, preferably for 5 to 20 seconds. After thorough mixing, recyclate from inert construction and demolition waste with an upper fraction of 20 mm of the second type (brick, ceramic or mixed, alternatively concrete recyclate) is added to it under constant mixing, whereby the recyclate being added is recyclate from inert construction and demolition waste of a different type than the recyclate to which it is added, and the mixture thus obtained is mixed for another 5 to 40 seconds, preferably for 5 to 20 seconds. After that, finely ground brick, ceramic, mixed or concrete recyclate having a particle size of 5 to 250 μm, preferably 5 to 125 μm, and having a specific surface of 300 to 1500 m²/kg is added to it under constant mixing within 1 to 15 seconds, preferably within 1 to 10 seconds, or finely ground brick, ceramic, mixed or concrete recyclate and microsilica and/or at least one substituent thereof are added either one by one in any order or simultaneously, and the mixture thus obtained is mixed for a further 5 to 80 seconds, preferably for 5 to 40 seconds. After that, cement is added to it under constant mixing within 1 to 20 seconds, preferably within 1 to 10 seconds, or cement and at least one substituent thereof are added to it either one by one in any order or simultaneously within 1 to 15 seconds, preferably within 1 to 10 seconds, and the mixture thus obtained is mixed for a further 5 to 80 seconds, preferably for 5 to 40 seconds. As a substituent of cement it is possible to use another dose of finely ground brick, ceramic, mixed or concrete recyclate having a particle size of 5 to 250 μm, preferably 5 to 125 μm, and having a specific surface of 300 to 1500 m²/kg, which is dispersed in the concrete structure. Subsequently, this mixture is sprinkled with the entire dose of mixing water (which, if necessary, contains at least one additive for concrete) under constant mixing within 5 to 60 seconds, preferably within 5 to 40 seconds, or the entire dose of the mixing water is sprayed onto the mixture within 5 to 60 seconds, preferably within 5 to 40 seconds. After a further 5 to 160 seconds of mixing, fresh concrete is prepared, in which 100% by weight of aggregate is composed of recyclate from inert construction and demolition waste.

3 samples of fresh concrete according to the invention were prepared by this method, whereby the composition of 1 m³ of each of them is described in Table 10.

TABLE 10

| Sample Component | ERC 3/1 | ERC 3/2 | ERC 3/3 |
|---|---|---|---|
| Mixed recyclate from | 755 | 1500 | 600 |
| mixed inert construction | | | |
| and demolition waste, | | | |
| fraction 0 to 20 mm [kg] | | | |
| Brick recyclate, | 765 | 580 | 1200 |
| fraction 0 to 20 mm [kg] | | | |
| Microsilica [kg] | 10 | 0 | 15 |
| Finely ground recyclate | 15 | 75 | 80 |
| from inert construction | | | |
| and demolition waste | | | |
| [kg] | | | |
| Cement [kg] | 200 | 200 | 200 |
| Substituent of cement | 100/20 | 50/50 | 120/100 |
| [kg]/finely ground | | | |
| recyclate from inert | | | |
| construction and | | | |
| demolition waste [kg] | | | |
| Concrete plasticizer or | 6.0 | 6.0 | 6.0 |
| superplasticizer [kg] | | | |
| Water [kg] | 247 | 130 | 225 |
| Aerating agent for | 0 | 0 | 0 |
| concrete [%] | | | |
| Volume weight of | 2210 | 2750 | 2730 |
| concrete at age of 7 | | | |
| days [kg/m³] | | | |
| Volume weight of | 2200 | 2750 | 2720 |
| concrete at age of 28 | | | |
| days [kg/m³] | | | |

These concretes were subsequently subjected to the tests described in example 2. The results of these tests are summarized in Table 11.

TABLE 11

| Sample Parameter | ERC 3/1 | ERC 3/2 | ERC 3/3 |
|---|---|---|---|
| Consistency of | 190 | 30 | 190 |
| fresh concrete - | | | |
| slump cone test | | | |
| [mm] | | | |
| Air content in fresh | 5.5 | — | 4.5 |
| concrete [%] | | | |
| Compressive | 28.5 | 17.0 | 27.1 |
| strength [MPa] | | | |
| After 7 days | | | |
| After 28 days | 39.4 | 24.5 | 38.9 |
| Static modulus of | 21.0 | 14.5 | 20.5 |
| elasticity [GPa] | | | |

In addition, chloride content in this concrete was determined by calculation according to EN 196-2 and EN 1744-1, the content of natural radionuclides and mass activity index were determined following the procedure of Regulation of the State Office for Nuclear Safety No. 307/2002 Coll., as amended, on radiation protection, whereby all these parameters meet the requirements of this Regulation for use for buildings with residential rooms or spaces (mass activity ²²⁶Ra≤150 Bq·kg⁻¹, mass activity index I≤0.5). According to the procedure of EN 12457 and Regulation of the Ministry of the Environment No. 294/2005 Coll., its ecotoxicity was found to be complying with the requirements. The criteria for determination of ecotoxicity are shown in Table 4, example 1.

Table 12 shows strength classes of concrete to which the respective concretes according to the invention belong due to their physical and mechanical parameters and classification classes of specification regarding use of these concretes according to CSN (Czech Technical Standard) EN 206 (see Table 6).

TABLE 12

| Sample | ERC 3/1 | ERC 3/2 | ERC 3/3 |
|---|---|---|---|
| Concrete | C25/30 | C16/20 | C25/30 |
| strength | | | |
| class | | | |
| Specification | X0 | X0 | X0 |
| of concrete | XC1 | XC1 | XC1 |
| use | XC2 | | XC2 |
| | XC3 | | XC3 |
| | XC4 | | XC4 |
| | XD1 | | XD1 |
| | XD2 | | XD2 |
| | XF1 | | XF1 |
| | XF2 | | XF2 |

### Example 4

For the preparation of concrete according to the invention, recyclate from inert construction and demolition waste with an upper fraction of 20 mm of the first type (brick, ceramic or mixed, alternatively concrete recyclate) is mixed in an industrial mixer with forced circulation for 5 to 40 seconds, preferably for 5 to 20 seconds. After thorough mixing, recyclate from inert construction and demolition waste with an upper fraction of 20 mm of the second type (brick, ceramic or mixed, alternatively concrete recyclate) is added to it under constant mixing, whereby the recyclate being added is recyclate from inert construction and demolition waste of a different type than the recyclate to which it is added, and the mixture thus obtained is mixed for another 5 to 40 seconds, preferably for 5 to 20 seconds. After thorough mixing, recyclate from inert construction and demolition waste with an upper fraction of 20 mm or natural aggregate with an upper fraction of 20 mm, preferably 8 mm, or small aggregate with an upper fraction of 4 mm (up to 40% by weight of the total aggregate in the concrete) is added to it under constant mixing and the mixture thus obtained is mixed for a further 5 to 40 seconds. Thereafter, finely ground brick, ceramic, mixed or concrete recyclate having a particle size of 5 to 250 μm, preferably 5 to 125 μm, and having a specific surface of 300 to 1500 m²/kg is added to it under constant mixing within 1 to 15 seconds, preferably within 1 to 10 seconds, or finely ground brick, ceramic, mixed or concrete recyclate and microsilica and/or at least one substituent thereof are added to it either one by one in any order or simultaneously, and the mixture thus obtained is mixed for a further 5 to 80 seconds, preferably for 5 to 40 seconds. After that, cement is added to it under constant mixing within 1 to 20 seconds, preferably within 1 to 10 seconds, or cement and at least one substituent thereof is added to it within 1 to 15 seconds, preferably within 1 to 10 seconds either one by one in any order or simultaneously, and the mixture thus obtained is mixed for a further 5 to 80 seconds, preferably for 5 to 40 seconds. As a substituent of cement it is possible to use another dose of finely ground brick, ceramic, mixed or concrete recyclate having a particle size of 5 to 250 μm, preferably 5 to 125 μm, and having a specific surface of 300 to 1500 m²/kg, which is dispersed in the concrete structure. Subsequently, this mixture is sprinkled with the entire dose of mixing water (which, if necessary, contains at least one additive for concrete) under constant mixing within 5 to 60 seconds, preferably within 5 to 40 seconds, or the entire dose of mixing water is sprayed on it within 5 to 60 seconds, preferably within 5 to 40 seconds. After another 5 to 160 seconds, preferably after 5 to 80 seconds, of mixing, fresh concrete is prepared, in which it is up to 100% by weight of aggregate that is composed of recyclate from inert construction and demolition waste.

3 samples of fresh concrete according to the invention were prepared by this method, whereby the composition of 1 m³ of each of them is described in Table 13.

TABLE 13

| Sample Component | ERC 4/1 | ERC 4/2 | ERC 4/3 |
|---|---|---|---|
| Mixed recyclate from | 500 | 0 | 420 |
| mixed inert construction | | | |
| and demolition waste, | | | |
| fraction 0 to 20 mm [kg] | | | |
| Brick recyclate, | 500 | 900 | 500 |
| fraction 0 to 20 mm [kg] | | | |
| Ceramic recyclate, | 0 | 500 | 0 |
| fraction 0 to 20 mm [kg] | | | |
| Concrete recyclate, | 700 | 300 | 500 |
| fraction 0 to 20 mm [kg] | | | |
| Microsilica [kg] | 15 | 25 | 20 |
| Finely ground recyclate | 10 | 20 | 50 |
| from inert construction | | | |
| and demolition waste | | | |
| Cement [kg] | 230 | 300 | 180 |
| Substituent of cement | 90/90 | 0 | 150/120 |
| [kg]/finely ground | | | |
| recyclate from inert | | | |
| construction and | | | |
| demolition waste [kg] | | | |
| Concrete plasticizer or | 4.9 | 5.5 | 4.5 |
| superplasticizer [kg] | | | |
| Water [kg] | 230 | 190 | 200 |
| Volume weight of | 2400 | 2370 | 2200 |
| concrete at age of 7 | | | |
| days [kg/m³] | | | |
| Volume weight of | 2370 | 2350 | 2190 |
| concrete at age of 28 | | | |
| days [kg/m³] | | | |

These concretes were subsequently subjected to the tests described in example 2. The results of these tests are summarized in Table 14.

TABLE 14

| Sample Parameter | ERC 4/1 | ERC 4/2 | ERC 4/3 |
|---|---|---|---|
| Consistency of | 190 | 200 | 140 |
| fresh concrete - | | | |
| slump cone test | | | |
| [mm] | | | |
| Air content in fresh | 5.1 | 4.5 | 4.2 |
| concrete [%] | | | |
| Compressive | 22.3 | 25.4 | 21.2 |
| strength [MPa] | | | |
| After 7 days | | | |
| After 28 days | 37.2 | 39.4 | 34.7 |
| Flexural strength | 3.8 | 3.5 | — |
| after 28 days [MPa] | | | |
| Static modulus of | 21.3 | 21.8 | 20.5 |
| elasticity [GPa] | | | |

In addition, chloride content in this concrete was determined by calculation according to EN 196-2 and EN 1744-1, the content of natural radionuclides and mass activity index were determined following the procedure of Regulation of the State Office for Nuclear Safety No. 307/2002 Coll., as amended, on radiation protection, whereby all these parameters meet the requirements of this Regulation for use for buildings with residential rooms or spaces (mass activity ²²⁶Ra≤150 Bq·kg⁻¹, mass activity index I≤0.5). According to the procedure of EN 12457 and Regulation of the Ministry of the Environment No. 294/2005 Coll., its ecotoxicity was found to be complying with the requirements. The criteria for determination of ecotoxicity are shown in Table 4, example 1.

Table 15 shows strength classes of concrete to which the respective concretes according to the invention belong due to their physical and mechanical parameters and classification classes of specification regarding use of these concretes according to CSN (Czech Technical Standard) EN 206 (see Table 6).

TABLE 15

| Sample | ERC 4/1 | ERC 4/2 | ERC 4/3 |
|---|---|---|---|
| Concrete | C25/30 | C25/30 | C25/30 |
| strength | | | |
| class | | | |
| Specification | X0 | X0 | X0 |
| of concrete | XC1 | XC1 | XC1 |
| use | XC2 | XC2 | XC2 |
| | XC3 | XC3 | XC3 |
| | XC4 | XC4 | XC4 |
| | XD1 | XD1 | XD1 |
| | XD2 | XD2 | XD2 |
| | XA1 | XA1 | XA1 |

### Example 5

For the preparation of concrete according to the invention, concrete recyclate with an upper fraction of 20 mm is mixed in an industrial mixer with forced circulation for 5 to 40 seconds, preferably for 5 to 20 seconds. After thorough mixing, natural aggregate with an upper fraction of 20 mm (up to 40% by weight of the total aggregate in concrete) is added to it under constant mixing, and the mixture thus obtained is mixed for another 5 to 40 seconds, preferably for 5 to 20 seconds. After that, finely ground brick, ceramic, mixed or concrete recyclate having a particle size of 5 to 250 μm, preferably 5 to 125 μm, and having a specific surface of 300 to 1500 m²/kg is added to it under constant mixing within 1 to 15 seconds, preferably within 1 to 10 seconds, or finely ground brick, ceramic, mixed or concrete recyclate and microsilica and/or at least one substituent of microsilica are added to it either one by one in any order or simultaneously, and the mixture thus obtained is mixed for a further 5 to 80 seconds, preferably for 5 to 40 seconds. Subsequently, cement is added to it under constant mixing within 1 to 20 seconds, preferably within 1 to 10 seconds, or cement and at least one substituent thereof is added to it one by one in any order or simultaneously within 1 to 15 seconds, preferably within 1 to 10 seconds, and the mixture thus obtained is mixed for another 5 to 80 seconds, preferably for 5 to 40 seconds. As a substituent of cement it is possible to use another dose of finely ground brick, ceramic, mixed or concrete recyclate, having a particle size of 5 to 250 μm, preferably 5 to 125 μm, and having a specific surface of 300 to 1500 m²/kg, which is dispersed in the concrete structure. Subsequently, the mixture is sprinkled with the entire dose of mixing water (which, if necessary, contains at least one additive for concrete) under constant mixing within 5 to 60 seconds, preferably within 5 to 40 seconds, or it is sprayed with the entire dose of mixing water within that period. After another 5 to 160 seconds, preferably after 5 to 80 seconds, of mixing, fresh concrete is prepared, in which at least 60% by weight of aggregate is composed of recyclate from inert construction and demolition waste.

5 samples of fresh concrete according to the invention were prepared by this method, whereby the composition of 1 m³ of each of them is described in Table 16.

TABLE 16

| Sample Component | ERC 5/1 | ERC 5/2 | ERC 5/3 | ERC 5/4 | ERC 5/5 |
|---|---|---|---|---|---|
| Concrete recyclate, | 1210 | 1000 | 980 | 800 | 860 |
| fraction 0 to 20 mm [kg] | | | | | |
| Natural aggregate, | 450 | 300 | 450 | 800 | 520 |
| fraction 0 to 4 mm [kg] | | | | | |
| Microsilica [kg] | 10 | 0 | 0 | 0 | 0 |
| Finely ground recyclate | 20 | 50 | 150 | 80 | 100 |
| from inert construction | | | | | |
| and demolition waste | | | | | |
| [kg] | | | | | |
| Cement [kg] | 220 | 200 | 150 | 190 | 190 |
| Substituent of cement | 50/0 | 100/40 | 150/100 | 150/120 | 150/150 |
| [kg]/finely ground | | | | | |
| recyclate from inert | | | | | |
| construction and | | | | | |
| demolition waste [kg] | | | | | |
| Concrete plasticizer or | 0 | 5 | 3 | 1 | 0 |
| superplasticizer [kg] | | | | | |
| Water [kg] | 220 | 150 | 100 | 175 | 190 |
| Volume weight | 2480 | 2070 | 2210 | 2300 | 2210 |
| of concrete at age | | | | | |
| of 7 days [kg/m³] | | | | | |
| Volume weight | 2460 | 2060 | 2210 | 2290 | 2200 |
| of concrete at age | | | | | |
| of 28 days [kg/m³] | | | | | |

These concretes were subsequently subjected to the tests described in example 1. The results of these tests are summarized in Table 17.

TABLE 17

| Sample Parameter | ERC 5/1 | ERC 5/2 | ERC 5/3 | ERC 5/4 | ERC 5/5 |
|---|---|---|---|---|---|
| Consistency of fresh | 120 | 80 | 10 | 70 | 140 |
| concrete - slump cone | | | | | |
| test [mm] | | | | | |
| Air content in fresh | 2.4 | 4.5 | - | 3.0 | 2.5 |
| concrete [%] | | | | | |
| Compressive strength | 28.8 | 26.5 | 16.0 | 17.2 | 20.2 |
| [MPa] | | | | | |
| After 7 days | | | | | |
| After 28 days | 40.5 | 36.5 | 24.5 | 25.7 | 29.7 |
| Flexural strength | 3.8 | 3.2 | — | 2.2 | 2.7 |
| after 28 days [MPa] | | | | | |
| Static modulus | 24.5 | 23.1 | — | 17.0 | 17.7 |
| of elasticity [GPa] | | | | | |

In addition, chloride content in this concrete was determined by calculation according to EN 196-2 and EN 1744-1, the content of natural radionuclides and mass activity index were determined following the procedure of Regulation of the State Office for Nuclear Safety No. 307/2002 Coll., as amended, on radiation protection, whereby all these parameters meet the requirements of this Regulation for use for buildings with residential rooms or spaces (mass activity ²²⁶Ra≤150 Bq·kg⁻¹, mass activity index I≤0.5). According to the procedure of EN 12457 and Regulation of the Ministry of the Environment No. 294/2005 Coll., its ecotoxicity was found to be complying with the requirements. The criteria for determination of ecotoxicity are shown in Table 4, example 1.

Table 18 shows strength classes of concrete to which the respective concretes according to the invention belong due to their physical and mechanical parameters and classification classes of specification regarding use of these concretes according to CSN (Czech Technical Standard) EN 206 (see Table 6).

TABLE 18

| Sample | ERC 5/1 | ERC 5/2 | ERC 5/3 | ERC 5/4 | ERC 5/5 |
|---|---|---|---|---|---|
| Concrete | C25/30 | C25/30 | C16/20 | C16/20 | C20/25 |
| strength class | | | | | |
| Specification | X0 | X0 | X0 | X0 | X0 |
| of concrete | XC1 | XC1 | XC1 | XC1 | XC1 |
| use | XC2 | XC2 | | | XC2 |
| | XC3 | XC3 | | | XC3 |
| | XC4 | XC4 | | | XC4 |
| | XD1 | XD1 | | | XD1 |
| | XD2 | XD2 | | | XD2 |
| | XA1 | XA1 | | | |

In all the above cases, it is possible to replace up to 40% by weight, preferably up to 20% by weight or up to 15% by weight of the total aggregate in the concrete with artificial aggregate (such as agloporite, ceramsite, expandit, expanded perlite, etc.) and/or cinder and/or scoria and/or polystyrene and/or at least one organic filler (such as wood sawdust, shavings, rice husks, shives, etc.) and/or another component for improving thermal and/or acoustic and/or fire resistance properties of hardened concrete. Preferably, this material is added prior to the addition of microsilica and/or substituent(s) thereof. In all these cases, recyclate from inert construction and demolition waste constitutes at least 45% by weight of the total aggregate in the concrete.

If necessary, it is possible to add to any of the concretes described above reinforcing fibers of at least one type which reinforce the concrete structure and thereby improve some of its properties, e.g. tensile strength and flexural strength. Such suitable reinforcing fibers are, e.g., polypropylene (PP) fibers, polyvinyl alcohol (PVA) fibers, blends of polypropylene and polyethylene (PLV) fibers, cellulose fibers, steel fibers, glass fibers, carbon fibers, Kevlar fibers, etc. These fibers are preferably added to the concrete mixture after the addition of finely ground brick, ceramic, mixed or concrete recyclate or a mixture of finely ground brick, ceramic, mixed or concrete recyclate and microsilica and/or at least one substituent(s) thereof and after thorough mixing of the mixture obtained. The total amount of all reinforcing fibers is 0.6 to 1.2 kg/m³ of fresh concrete, in the case of steel and similar fibers the total amount being up to 25 kg/m³ of fresh concrete. Reinforcing fibers are added to the concrete mixture under constant mixing within 5 to 30 seconds, which ensures their uniform distribution in it.

If all the components of the aggregate with an upper fraction of 8 mm are used, fresh concrete with a finer texture is prepared using the same processes, sometimes referred to as cement mortar or concrete mortar.

The 0 to 20 mm aggregate fraction described in the above examples does not limit the implementation of the invention, since both natural aggregate and recyclate from inert construction and demolition waste may have a higher limit of the upper fraction.

All the concretes according to the invention are designed for both manual and machine processing (including shotcrete) and are suitable for conventional concrete structures from both plain concrete and ferroconcrete. In addition to fresh concrete (transport concrete) for the construction of houses, hotels, residential buildings, office buildings, industrial buildings, production halls, special purpose facilities, medical facilities, etc., or for their parts, such as pillars and posts, floors, lintels in lengths up to approximately 6 m, base plates or bases, foundation concrete, etc., these concretes can be also used for the production of concrete products and prefabricated elements, e.g., concrete blocks and bricks, paving cobbles, slabs, blocks, curbs, various elements of garden architecture, ceiling beams and inserts, etc. Their advantage is good transportability, or, pumpability. Moreover, all variants are concretes which are 100% recyclable in the same way they were produced.

1. Fresh concrete, wherein it contains in 1 m3 50 to 300 kg of water, 135 to 400 kg of cement or 135 to 600 kg of a mixture of cement and at least one substituent thereof, 10 to 150 kg of finely ground recyclate from inert construction and demolition waste having a particle size of 5 to 250 μm and a specific surface of 300 to 1500 m2/kg or 10 to 150 kg of a mixture of finely ground recyclate from inert construction and demolition waste having a particle size of 5 to 250 μm and a specific surface of 300 to 1500 m2/kg in combination with microsilica and/or at least one substituent thereof with a content of finely ground recyclate in this combination of at least 10% by weight, and 1000 to 2300 kg of aggregate, whereby 45 to 100% of the aggregate is formed by recyclate from inert construction and demolition waste, 0 to 40% of aggregate is formed by natural aggregate and 0 to 40% of aggregate consists of lightweight artificial aggregate and/or cinder and/or scoria and/or polystyrene and/or at least one organic filler and/or another component for improving thermal and/or acoustic and/or fire resistance properties of hardened concrete, whereby the aggregate grains are coated and their pores are filled with finely ground recyclate from inert construction and demolition waste or with a mixture of finely ground recyclate from inert construction and demolition waste and microsilica and/or at least one substituent thereof, and cement paste formed by the moistening of cement or substituent(s) thereof is adhered to the aggregate particles thus treated.

2. The fresh concrete according to claim 1, wherein in that it further contains 10 to 290 kg of finely ground recyclate from inert construction and demolition waste having a particle size of s 5 to 250 μm and having a specific surface of 300 to 1500 m2/kg, which is incorporated in cement paste formed by moistening cement or substituent(s) thereof.

3. The fresh concrete according to claim 1, wherein 60 to 100% of aggregate consists of recyclate from inert construction and demolition waste.

4. The fresh concrete according to claim 1, wherein it further contains at least one additive for concrete, whereby the total amount of all the additives for concrete added is up to do 10% by weight of the dose of cement or of the dose of cement and substituent(s) thereof.

5. The fresh concrete according to claim 1, wherein it further contains reinforcing fibers in an amount of 0.6 to 25 kg/m3 of fresh concrete.

6. The fresh concrete according to claim 1, wherein the substituent of cement is finely ground recyclate from inert construction and demolition waste having a particle size of 5 to 250 μm and a specific surface of 300 to 1500 m2/kg in a dose of 10 to 150 kg/m3 of fresh concrete.

7. The Fresh concrete according to claim 1, characterized in that the finely ground recyclate from inert construction and demolition waste has a particle size of 5 to 125 μm.

8. A dry mixture for the preparation of fresh concrete according to claim 1, wherein it contains when computed for 1 m3 of fresh concrete 10 to 150 kg of finely ground recyclate from inert construction and demolition waste having a particle size of 5 to 250 μm and a specific surface of 300 to 1500 m2/kg, or finely ground recyclate in combination with microsilica and/or at least one substituent thereof, with a content of the finely ground recyclate in this combination of at least 10% by weight, and 1000 to 2300 kg of aggregate, 45 to 100% by weight of the aggregate being composed of recyclate from inert construction and demolition waste, whereby the aggregate grains are coated and their pores are filled with the finely ground recyclate from inert construction and demolition waste or with the mixture of the finely ground recyclate from inert construction and demolition waste and the microsilica and/or at least one substituent thereof.

9. The dry mixture according to claim 8, wherein it further contains 135 to 400 kg of cement, or cement and at least one substituent thereof in a total amount of 135 to 600 kg, whereby the ratio of cement to the substituent(s) of cement ranges from 30:70 to 70:30.

10. The dry mixture according to claim 8, wherein the particles of the finely ground recyclate from inert construction and demolition waste have a size of 5 to 125 μm.

11. A method for the preparation of 1 m3 of fresh concrete using recyclate from inert construction and demolition waste, wherein 1000 to 2300 kg of aggregate, in which 45% by weight to 100% by weight consists of recyclate from inert construction and demolition waste, is mixed in a mixer with 10 to 150 kg of finely ground recyclate from inert construction and demolition waste having a particle size of 5 to 250 μm and a specific surface of 300 to 1500 m2/kg or with 10 to 150 kg of a mixture of finely ground recyclate from inert construction and demolition waste having a particle size of 5 to 250 μm and a specific surface of 300 to 1500 m2/kg and of microsilica and/or of at least one substituent thereof, with a content of finely ground recyclate in this combination of at least 10% by weight, whereby the finely ground recyclate from inert construction and demolition waste, optionally in combination with microsilica and/or at least one substituent thereof, coats the aggregate particles and fills the pores in them, and after thorough mixing, 135 to 400 kg of cement is added to the mixture thus obtained under constant mixing, or cement and at least one substituent thereof in a total amount of 135 to 600 kg are added to it either one by one in any order or simultaneously under constant mixing, and after mixing the mixture thus obtained, this mixture is sprinkled with 50 to 300 kg of mixing water under constant mixing, or it is sprayed with this amount of the mixing water, whereby the surface of cement or the surface of the substituent(s) thereof is gradually moistened and the (cement) paste thus formed gradually adheres to the grains of the recyclate already coated with the finely ground recyclate from inert construction and demolition waste or with this recyclate in combination with microsilica and/or at least one substituent thereof, and after further mixing of this mixture, fresh concrete is prepared.

12. The method according to claim 11, wherein 1000 to 2300 kg of aggregate, in which 45% by weight to 100% by weight is formed by recyclate from inert construction and demolition waste is mixed in a mixer for 5 to 40 seconds with 10 to 150 kg of finely ground recyclate from inert construction and demolition waste having a particle size of 5 to 250 μm and a specific surface of 300 to 1500 m2/kg or with 10 to 150 kg of a mixture of finely ground recyclate from inert construction and demolition waste having a particle size of 5 to 250 μm and a specific surface of 300 to 1500 m2/kg and microsilica and/or at least one substituent thereof, with a content of finely ground recyclate of at least 10% by weight in this combination, whereby the finely ground recyclate from inert construction and demolition waste, optionally in combination with microsilica and/or at least one substituent thereof, coats the aggregate grains and fills the pores in them, whereby after thorough mixing, 135 to 400 kg of cement is added to the mixture thus obtained under constant mixing within 1 to 20 seconds, or cement and at least one substituent thereof in a total amount of 135 to 600 kg is added to it under constant mixing within 1 to 20 seconds either one by one in any order or simultaneously, and the mixture thus obtained is mixed for a further 5 to 80 seconds, whereupon the mixture is sprinkled with 50 to 300 kg of mixing water under constant mixing within 5 to 60 seconds, or this amount of the mixing water is sprayed onto it within 5 to 60 seconds, whereby the surface of cement or the surface of substituent(s) thereof is gradually moistened and the (cement) paste thus formed gradually adheres to the grains of the recyclate already coated with the finely ground recyclate from inert construction and demolition waste, optionally in combination with microsilica and/or at least one substituent thereof, and after another 5 to 160 seconds of mixing, fresh concrete is prepared.

13. The method according to claim 11, wherein at first, aggregate is mixed in a mixer and after thorough mixing, finely ground recyclate from inert construction and demolition waste having a particle size of 5 to 250 μm and a specific surface of 300 to 1500 m2/kg is added to it under constant mixing, or finely ground recyclate from inert construction and demolition waste having a particle size of 5 to 250 μm and a specific surface of 300 to 1500 m2/kg and microsilica and/or at least one substituent thereof are added to it either one by one in any order or simultaneously, whereby the content of the finely ground recyclate in this combination is at least 10% by weight, and the mixture thus obtained is mixed.

14. The method according to claim 11, wherein at first, aggregate is mixed in a mixer for 5 to 40 seconds and after thorough mixing, finely ground recyclate from inert construction and demolition waste having a particle size of 5 to 250 μm and a specific surface of 300 to 1500 m2/kg is added to it under constant mixing within 1 to 15 seconds, or finely ground recyclate from inert construction and demolition waste having a particle size of 5 to 250 μm and a specific surface of 300 to 1500 m2/kg and microsilica and/or at least one substituent thereof are added to it either one by one in any order or simultaneously, whereby the content of the finely ground recyclate in this combination is at least 10% by weight, and the mixture thus obtained is mixed for a further 5 to 80 seconds.

15. The method according to claim 11, wherein the finely ground brick recyclate is brick dust from brick grinding or from brick kilns having a particle size of 5 to 250 μm and a specific surface of 300 to 1500 m2/kg.

16. The method according to claim 11, wherein a substituent of microsilica is metakaolin or shale with a content of silicon dioxide of at least 45% by weight.

17. The method according to claim 11, wherein up to 40% by weight of the total aggregate is composed of natural aggregate.

18. The method according to claim 11, wherein up to 40% by weight of the total aggregate is composed of lightweight artificial aggregate and/or cinder and/or scoria and/or polystyrene and/or at least one organic filler and/or another component for improving thermal and/or acoustic and/or fire resistance properties of hardened concrete.

19. The method according to claim 11, wherein at least one additive for concrete is added to the mixture being prepared together with mixing water or after the mixing water, whereby the total amount of all the additives for concrete added is up to 10% by weight of the dose of cement or the dose of cement and substituent(s) thereof.

20. The method according to claim 11, wherein after the addition of finely ground recyclate from inert construction and demolition waste or of finely ground recyclate from inert construction and demolition waste in combination with microsilica and/or at least one substituent thereof, and after mixing the mixture thus obtained, reinforcing fibers of at least one type are added to it under constant mixing, whereby the total amount of all reinforcing fibers ranges from 0.6 to 25 kg/m3 of fresh concrete.

21. The method according to claim 11, wherein the substituent of cement is finely ground recyclate from inert construction and demolition waste having a particle size of 5 to 250 μm and a specific surface of 300 to 1500 m2/kg in a dose of 10 to 150 kg/m3 of fresh concrete, which is during mixing incorporated into cement paste formed by moistening cement or substituent(s) thereof.

22. The method according to claim 11, wherein the recyclate from inert construction and demolition waste has a particle size of 5 to 125 μm.
